(19) United States
(12) Patent Application Publication
(10) Pub. No.: US 2012/0167713 A1
(43) Pub. Date: Jul. 5, 2012

(54) ENGINE STARTUP DEVICE

(76) Inventors: Shibin XIE, Shenzhen (CN); Ou Ruan, Shenzhen (CN); Zhen Zhai, Shenzhen (CN); Qiang Tian, Shenzhen (CN)

(21) Appl. No.: 13/340,201

(22) Filed: Dec. 29, 2011

(30) Foreign Application Priority Data
Dec. 29, 2010 (CN) 201020686492.1

(51) Int. Cl. F02N 15/02

(52) U.S. Cl. 74/7 C

(57) ABSTRACT

A startup device includes a starting motor, a drive gear mounted on an output shaft of the starting motor, a transmission mechanism, and a fly wheel. The transmission mechanism further includes a first gear engaging with the drive gear, and at least three second gears, each being disposed on an end face of the first gear through a unidirectional overrunning clutch. Each unidirectional overrunning clutch is mounted on a mounting shaft disposed on the end face of the first gear. The startup device further includes a third gear disposed on and end face of the fly wheel and engaged with the third gears.

### CROSS-REFERENCE TO RELATED APPLICATIONS

The present application claims priority to and benefits of Chinese Patent Application No. 201020686492.1 filed on Dec. 29, 2010, the entirety of which is hereby incorporated by reference.

### TECHNICAL FIELD

The present disclosure relates to an engine startup device.

### BACKGROUND

Starting an engine needs support from an external startup device. Generally speaking, the startup device has three components to realize the starting of the engine. A direct current motor receives an electric current from a battery and drives the startup device to produce a mechanical motion. A transmission mechanism causes a drive gear to engage a gear of a fly wheel, when starting the engine, and to disengage the gear of the fly wheel, after the starting of the engine. A magnetic switch is used to connect and disconnect the startup device circuit.

An electric startup device including an electric motor is widely used in modern vehicles. Depending on the direct current motor used in the system, the startup device can be categorized into a regular starting device or a magnetic starting device. These two types of startup device differ in their control devices and transmission mechanisms.

The transmission mechanisms may have an inertia interlocking form, a compulsory interlocking form, or a soften interlocking form. In a compulsory interlocking startup device, when the starting switch is turned on, the drive gear may extend out to interlock with an annular gear of the fly wheel. After the engine is started, the starting switch is turned off, then the external force may be eliminated, and the drive gear may be turned back under the action of the return spring. During the interlocking between the drive gear and the annular gear of the fly wheel, the drive gear and the annular gear of the fly wheel may interfere and collide with each other, causing damages to the annular gear of the fly wheel and generating noises.

### SUMMARY

The present disclosure provides an engine startup device that can reduce noises during engine startup. One embodiment of the present disclosure provides an engine startup device comprising a starting motor, a drive gear, and a fly wheel. The drive gear is mounted on an output shaft of the starting motor. The engine startup device further comprises a transmission mechanism which includes a first gear engaging with the drive gear and at least three second gears. An end face of a first gear has at least three mounting shafts. Each second gear may be mounted on one of the mounting shafts via a unidirectional overrunning clutch. A third gear is disposed on an end face of the fly wheel. The second gears are engaged with the third gear.

Furthermore, the at least three second gears are disposed at equal intervals along a circumferential direction on the end face of the first gear. The third gear is mounted among the three second gears and engaged with the three second gears. The third gear is formed with the fly wheel integrally. The fly wheel has a support shaft and the third gear is disposed on the support shaft. The first gear may be mounted to the support shaft via a bearing. The end face of the support shaft has at least one through hole configured to provide connections between the fly wheel and a crankshaft of the engine.

The unidirectional overrunning clutch further comprises an outer ring and an inner ring. Each second gear is mounted on the unidirectional overrunning clutch through an interference fit between the second gear and the outer ring. Each unidirectional overrunning clutch is mounted on the mounting shaft through an interference fit between the inner ring and the mounting shaft.

Because of the all-time engagements between gears and the unidirectional overrunning clutches, the startup device of the present disclosure requires no compulsory engagement and effectively reduce the noise and shorten the starting time accordingly.

### BRIEF DESCRIPTION OF THE DRAWINGS

These and other aspects and advantages of the invention will become apparent and more readily appreciated from the following descriptions taken in conjunction with the drawings in which:

FIG. 1 is a schematic view of the startup device according to an embodiment of the present disclosure;

FIG. 2 is an exploded view of the startup device according to an embodiment of the present disclosure; and

FIG. 3 is a schematic view of the fly wheel, the third gear, and the support shaft of the startup device according to an embodiment of the present disclosure.

### DETAILED DESCRIPTION

Reference will be made in detail to embodiments of the present invention. The embodiments described herein according to drawings are explanatory, illustrative, and used to generally understand the present invention. The embodiments shall not be construed to limit the present invention. The same or similar elements and the elements having same or similar functions are denoted by like reference numerals throughout the descriptions.

The engine startup device described herein comprises two sections: 1) a direct current motor (such as a direct current series motor) that functions as the starting motor, which converts electric power input from a battery to mechanical power and then generates magnetic torsions; and 2) a transmission mechanism, i.e., a starter clutch or a mesh equipment, which engages the drive gear at the output shaft of the starting motor with an annular ring of the fly wheel, transmits the torsion of the starting motor to a crank shaft of the engine, and, after the engine is started, disengages the drive gear at the output shaft of the starting motor with the annular ring of the fly wheel automatically.

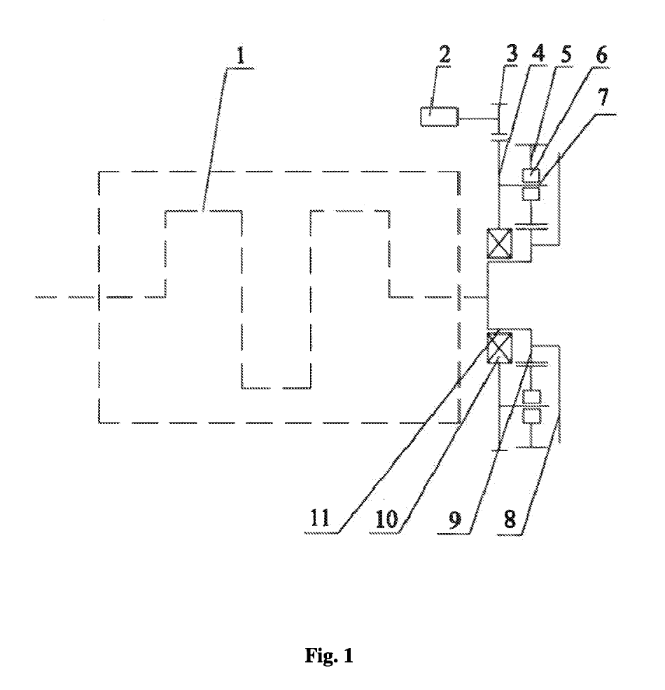

As shown in FIGS. 1-3, according to an embodiment of the present disclosure, a startup device comprises a starting motor 2, a drive gear 3, and a fly wheel 8. The drive gear 3 is mounted on an output shaft of the starting motor 2. The startup device further comprises a transmission mechanism that includes: a first gear 4 engaging with the drive gear 3 and at least three second gears 5, wherein three mounting shafts 7 are disposed on an end face of the first gear 4 and each second gear 5 is mounted on the mounting shaft 7 via a unidirectional overrunning clutch 6. A third gear 9 is disposed on an end face of the fly wheel 8 and is engaged with all second gears 5.

The starting motor 2 may be any kind of motor, such as a direct current motor. The drive gear 3 may be mounted on the output shaft of the starting motor 2 by various Methods, such as a spline coupling. When the starting motor 2 rotates, the output shaft of the starting motor 2 drives the drive gear 3 to rotate as well.

The drive gear 3 and the first gear 4 are engaged with each other at all time. As a result, power can be transmitted from the drive motor 2 to the first gear 4 through the drive gear 3, without compulsory engagement between gears, thereby reducing noises and protecting the starting motor 2.

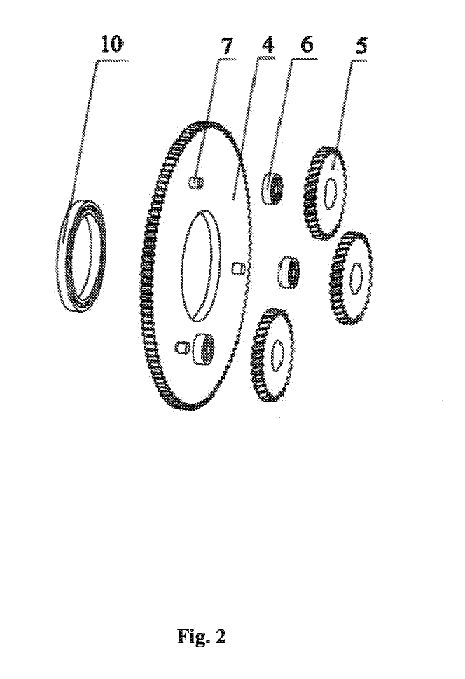

Furthermore, as shown in FIGS. 1 and 2, three second gears 5 are mounted on the end face of the first gear 4 through three mounting shafts 7, respectively. The mounting shafts 7 are disposed on the end face of the first gear 4 by various methods. For example, the mounting shafts 7 and the first gear 4 can be formed integrally. Alternatively, the mounting shafts 7 may be fixed to the end face of the first gear 4 through a spline coupling or an interference fit.

A unidirectional overrunning clutch 6 is disposed between each pair of the second gear 5 and the mounting shaft 7. After the engine is started, the unidirectional overrunning clutches 6 disconnect the engine from the starting motor 2. Each unidirectional overrunning clutch 6 has an outer ring and an inner ring. The second gear 5 is mounted on the outer ring through an interference fit. The inner ring is mounted on the mounting shaft 7 through an interference fit. The unidirectional overrunning clutch 6 may have a small size to fit between the second gear 5 and the mounting shaft 7. The unidirectional overrunning clutch 6 may be selected from various suitable unidirectional overrunning clutches, such as a roller-type unidirectional overrunning clutch or a wedge-type unidirectional overrunning clutch. According to different types of unidirectional overrunning clutches, there may be wedges or rollers between the outer ring and inner ring of the unidirectional overrunning clutch 6.

When the first gear 4 rotates, the second gear 5 may be rotated with the first gear 4. As a result, the outer ring of the unidirectional overrunning clutch 6 may rotate relatively to the inner ring, thereby causing interlocking between the inner ring and the outer ring. For example, the wedges between the inner ring and the outer ring may block the relative movements between the inner ring and the outer ring. Accordingly, the unidirectional overrunning clutch 6 is in an interlocking state. Hence, the second gear 5 may move along with the rotation of the first gear 4. But the second gear 5 and the first gear 4 have no relative movements and the second gear 5 does not rotate on the shaft 7.

At the meantime, the three second gears 5 and the third gear 9 also have no relative rotations. Thus, the third gear 9 also move along with the rotation of the first gear 4, thereby driving the fly wheel 8 and hence the crankshaft 1 of the engine. In other words, the first gear 4, the second gear 5, the third gear 9, and the fly wheel 8 have no relative movements and may rotate at the same rotational speed. Therefore, the first gear 4, the second gear 5, the third gear 9, and the fly wheel 8 may work integrally, thereby increasing the rotational inertia of the fly wheel 8.

When the rotational speed of the crank shaft 1 of the engine reaches a predetermined speed, the engine starts to fire up. As a result, the rotational speed of the crankshaft 1 increases. Hence, when the rotational speed of the third gear 9 reaches a preset speed (i.e., when the speed of the third gear 9 starts to exceed the rotational speed of the first gear 4), the third gear 9 starts to drive the second gears 5. As a result, the rotating direction of the second gear 5 becomes opposite to the rotating direction of the first gear 4, thereby disengaging the interlocking between the inner ring and the outer ring of the clutch 6. That is, the unidirectional overrunning clutch 6 is in a disengaged state, breaking the power transmission between the second gear 5 and the first gear 4 and cutting off the power transmission from the starting motor 2 to the engine.

Furthermore, the third gear 9 is disposed among three second gears 5 and engaged with the three second gears 5 simultaneously. That means, the engagement of the third gear 9 with the three second gear 5 is an external engagement, not an internal engagement. Therefore, the size of the third gear 9 can be small, saving installation space and reducing machining difficulty.

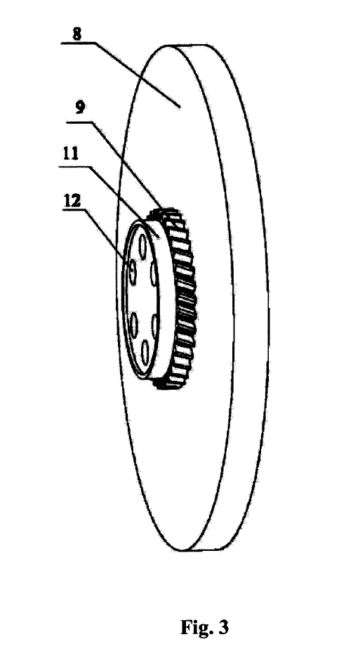

As shown in FIG. 3, the third gear 9 may be disposed on the end face of the fly wheel 8 by various methods. For example, the third gear 9 and the fly wheel 8 can be formed integrally.

In order to support the first gear 4, a supporting shaft 11 is further disposed on the fly wheel 8. The first gear 4 is mounted to the supporting shaft 11 via a bearing 10 and may require no additional supporting structures for supporting the first gear 4, such as an additional supporting shaft or an engine shell with a special structure. This arrangement may simplify the structure of the engine or the startup device and reduce the space that the startup device occupies.

Furthermore, as shown in FIG. 3, the third gear 9 is disposed on the supporting shaft 11. Accordingly, the supporting shaft 11, the third gear 9, and the fly wheel 8 may be formed integrally to strengthen the integration of the components and reduce manufacturing difficulty.

To transmit power between the fly wheel 8 and the crank shaft 1 of the engine, one or more through holes 12 are disposed on an end face of the supporting shaft 11 for connecting the fly wheel 8 and the crank shaft 1 of the engine. The fly wheel 8 may be connected to the crankshaft 1 of the engine through one or more bolts passing through the through holes 12.

According to embodiments of the present disclosure, the operation of the startup device is described hereinafter.

When starting an engine, a user can press a switch (not shown in the figures) to connect the starting motor 2 to a battery (not shown in the figures). When the starting motor 2 begins to rotate, driving the drive gear 3; the first gear 4 may begin to rotate due to the engagement between the drive gear 3 and the first gear 4. At the meantime, the unidirectional overrunning clutches 6 are in the engaged state. As a result, the first gear 4 causes the second gears 5 to move with the first gear 4, but the second gears 5 do not self-rotate at this time and hence have no movements with respect to the first gear 4. The second gears 5 then cause the third gear 9 to rotate. Still, there is no relative motion between the second gears 5 and the third gear 9 at this time. Thus, three second gears 5 drive the third gear 9 to rotate simultaneously, thereby driving the fly wheel 8 to rotate. As a result, the crankshaft 1 of the engine starts to rotate, driven by the fly wheel 8.

When the rotational speed of the crankshaft 1 of the engine reaches a predetermined speed, the engine starts to ignite. Meanwhile, the starting motor 2 may be turned off or stop working. When the rotational speed of the crankshaft 1 increases, the rotational speeds of the fly wheel 8 and the third gear 9 increase as well. At a predetermined speed, the third gear 9 begins to drive the second gear 5 to rotate on the mounting shaft 7. That is, the third gear 9 and the second gear 5 rotate with respect to each other. As a result, the outer ring and the inner ring of the unidirectional overrunning clutch 6 may be disengaged, putting the unidirectional overrunning clutch 6 in the disengaged state. Thus, the power transmission between the starting motor 2 and the engine is cut off, and the rotation of the second gear 5 is not transmitted to the first gear 4.

In some embodiments, the startup device of the present disclosure has a first gear 4 engaged with the drive gear 3, and three second gears 5 engaged with the third gear 9 of the fly wheel 8. And the second gears 5 may be mounted to the end face of the first gear 4 via a unidirectional overrunning clutch 6. Therefore, the startup device of the present disclosure requires no compulsory engagement. As a result, noise is reduced and the starting time is shortened.

Meanwhile, with reference to the startup device of the present disclosure, the drive gear 3 may be coupled with the starting motor 2 and engaged with the first gear 4. The first gear 4 may be coupled with the fly wheel 8 via the second gears 5 disposed on the end face of the first gear 4 and engaged with the third gear 9. The entire structure is simple and compact.

Using the three second gears 5 to drive the rotation of the third gear 9 may effectively reduce the radial dimension of the assembly. And the unidirectional overrunning clutch 6 is disposed between the second gear 5 and the mounting shaft 7 of the first gear 4 to effectively cut off the power transmission between the starting motor 2 and the engine after the engine is started.

Additionally, before the engine ignites, the first gear 4, the second gears 5, the third gear 9, and the fly wheel 8 form an integrated structure rotating at the same speed, thereby increasing the rotational inertia of the fly wheel 8 and beneficial for the operation of the engine.

Although explanatory embodiments have been shown and described, it would be appreciated by those skilled in the art that changes, alternatives, and modifications can be made in the embodiments without departing from spirit and principles of the disclosure. Such changes, alternatives, and modifications all fall into the scope of the claims and their equivalents.

What is claimed is:

1. A startup device comprising:
a starting motor;
a drive gear mounted on an output shaft of the starting motor;
a transmission mechanism including:
a first gear engaging with the drive gear; and
at least three second gears, each being disposed on an end face of the first gear through a unidirectional overrunning clutch, each unidirectional overrunning clutch being mounted on a mounting shaft disposed on the end face of the first gear;
a fly wheel; and
a third gear being disposed on an end face of the fly wheel and engaged with the second gears.

2. The startup device of claim 1, wherein the at least three second gears are disposed at equal intervals along a circumferential direction on the end face of the first gear.

3. The startup device of claim 2, wherein the third gear is mounted among the three second gears and engaged with the three second gears.

4. The startup device of claim 3, wherein the third gear is formed with the fly wheel integrally.

5. The startup device of claim 4, wherein the fly wheel has a support shaft and the third gear is mounted on the support shaft.

6. The startup device of claim 5, wherein the first gear is mounted on the support shaft via a bearing.

7. The startup device of claim 5, wherein an end face of the support shaft has at least one through hole configured to provide a connection between the fly wheel and a crankshaft of an engine.

8. The startup device of claim 1, wherein:
each unidirectional overrunning clutch includes an outer ring and an inner ring;
the corresponding second gear is mounted on the unidirectional overrunning clutch through an interference fit between the second gear and the outer ring; and
the unidirectional overrunning clutch is mounted on the mounting shaft on the end face of the first gear through an interference fit between the inner ring and the mounting shaft on the end face of the first gear.
